(19) United States
(12) Patent Application Publication
(10) Pub. No.: US 2016/0296939 A1
(43) Pub. Date: Oct. 13, 2016

(54) Continuous Grinding Device for Divided Solid Materials

(71) Applicant: FCD, Laburgade (FR)

(72) Inventor: Florent Cheinet, Laburgade (FR)

(73) Assignee: FCD, Laburgade (FR)

(21) Appl. No.: 15/037,868

(22) PCT Filed: Nov. 7, 2014
(86) PCT No.: PCT/EP2014/074103

§ 371 Date: May 19, 2016

(30) Foreign Application Priority Data
Nov. 28, 2013 (FR) 1361755

(51) Int. Cl. B02C 17/20; B02C 17/14

(52) U.S. Cl. CPC B02C 17/20; B02C 17/14

(57) ABSTRACT

A continuous grinding device for divided solid material has a chamber extending along a chamber axis, the chamber having an inlet orifice for receiving the material to be processed and an outlet orifice for extracting the processed material, and agitating means for conferring on the chamber an oscillatory translational movement in a plane perpendicular to the chamber axis with respect to a base. The grinding device also has inclining means for adjusting the orientation of the assembly formed by the agitating means and the chamber with respect to the base by way of a pivoting movement about an axis at an angle or perpendicular to the chamber axis. In addition, the device has a ring housed in the chamber and a weight passing through a housing of the ring, an external surface.

### TECHNICAL FIELD

The present invention relates to a grinding device for divided solid materials.

### STATE OF THE ART

Ball grinding machines are known for reducing a divided solid material into small pieces or into powder. Such a grinding machine includes for example at least one cylindrical chamber in which are confined the material to be ground and balls. The assembly is set into motion so as to have the balls roll by inertia in the chamber so that they crush the material. The setting into motion is for example accomplished by a planetary motion imparted to the chamber. The material is processed batchwise in the application of this grinding machine.

In document WO 93/00998 A1, a grinding device was proposed allowing a divided solid material to be continuously processed. The cylindrical chamber is driven into a planetary motion such that its orientation with respect to an outer marking is constant. Thus, the chamber is connected through a first end to a conduit for feeding the material to be ground and through its other end to an extraction conduit for discharging the processed material.

However, it proves to be difficult to control and influence the transit time of the material, so that the final grain size is difficult to control. In particular, certain grains of material may very rapidly cross the chamber and come out with a too large size, or on the contrary, the dwelling time may be too long and the obtained grain size too fine.

The invention aims at providing a continuous grinding device giving the possibility of controlling the transit time of the material in the chamber and the size of the outgoing particles.

### DESCRIPTION OF THE INVENTION

With these goals in mind, the object of the invention is a continuous grinding device for a divided solid material including a chamber extending along a chamber axis, the chamber including an inlet orifice for receiving the material to be processed and an outlet orifice for extracting the processed material, and stirring means for imparting to the chamber an oscillatory translational movement in a plane perpendicular to the chamber axis with respect to a base, the device being characterized in that it includes tilting means for adjusting the orientation of the assembly formed by the stirring means and the chamber, with respect to the base by pivoting around an axis oblique or perpendicular to the chamber axis.

The oscillatory translational movement in the plane perpendicular to the chamber axis gives the possibility of setting into motion the chamber and its contents by inertia. The tilt variation of the chamber axis gives the possibility of having an influence on the dwelling time of the material in the chamber, and therefore of controlling the grinding parameters such as the grain size. It is thus possible to obtain a fine grain size by reducing the tilt without increasing the speed of rotation, and therefore by retaining limited power. In the case of grinding of biological material, limitation of the power gives the possibility of obtaining separation on an extracellular scale, of much better quality, than if the cells are degraded, as this is frequently the case with hammer grinding machines.

According to a particular arrangement, the device includes a ring housed in the chamber and a centrifugal weight crossing a housing of the ring, an external surface of the ring and the housing having a same axis of revolution. The insertion into the cylinder of a ring combined with a centrifugal weight gives the possibility of increasing the surface areas against which the material is crushed, i.e. between the wall of the chamber and the ring, and between the ring and the centrifugal weight. Greater efficiency of the chamber is thereby obtained. Fine granularity is obtained even if the dwelling time remains moderate. The centrifugal weight and the housing may be cylindrical.

According to a first embodiment, the housing includes variations in diameter, the centrifugal weight being of an axisymmetrical shape and having the same profile as the housing. The variations in diameter of the profile of the centrifugal weight and of its housing give the possibility of making the path of the material longer between both ends of the ring by the housing. Good efficiency of the grinding is thereby ensured.

In a first alternative, the profile of the housing and of the centrifugal weight is corrugated. This shape ensures continuous variation of the profile and allows good repair of the material between the centrifugal weight and the ring.

In a second alternative, the profile of the housing and of the centrifugal weight is staged. This shape is easier to make, while remaining sufficiently effective.

According to an enhancement, a first diameter of a first end of the centrifugal weight is greater than a second diameter of its second end opposite to the first end. A great length is thereby ensured for the passage of the material through the housing.

For example, the ratio between the second diameter and the first diameter is greater than 1.5, preferably greater than 2.

According to a second embodiment, first spacers are interposed between the chamber and the ring. The spacers give the possibility of maintaining a spacing between the respective surfaces of the chamber and of the ring. Thus, it is possible to calibrate the crushing of the material between said surfaces in order to give preference to a grain size corresponding to the spacing determined by the first spacers.

The first spacers are for example attached at the periphery of the ring. The chamber may remain fixed while the ring is more mobile and may be changed or modified in order to adapt the spacing according to the processing to be carried out.

In a similar way, second spacers are interposed between the ring and the centrifugal weight. For example, the second spacers are fixed inside the ring. The same effect is obtained as with the first spacers, by generating a spacing between the housing of the ring and the centrifugal weight.

According to a particular embodiment, the spacers extend along a helix. The helix may for example be on the ring, in the housing or on the centrifugal weight.

### SHORT DESCRIPTION OF THE FIGURES

The invention will be better understood and other particularities and advantages will become apparent upon reading the description which follows, the description making reference to the appended drawings wherein:

FIG. 1 is a sectional view of a grinding device according to a first embodiment of the invention;

FIG. 2 is a view similar to FIG. 1 of an alternative of the first embodiment;

FIG. 3 is a view similar to FIG. 1 of a second embodiment of the invention;

FIG. 4 is a perspective view of a ring for the device of FIG. 3 according to an alternative.

### DETAILED DESCRIPTION

In the description which follows, the described grinding devices are intended to be used in a position oriented with respect to the vertical. The directions will be indicated relatively to this orientation, even if the devices may be temporarily placed in another orientation.

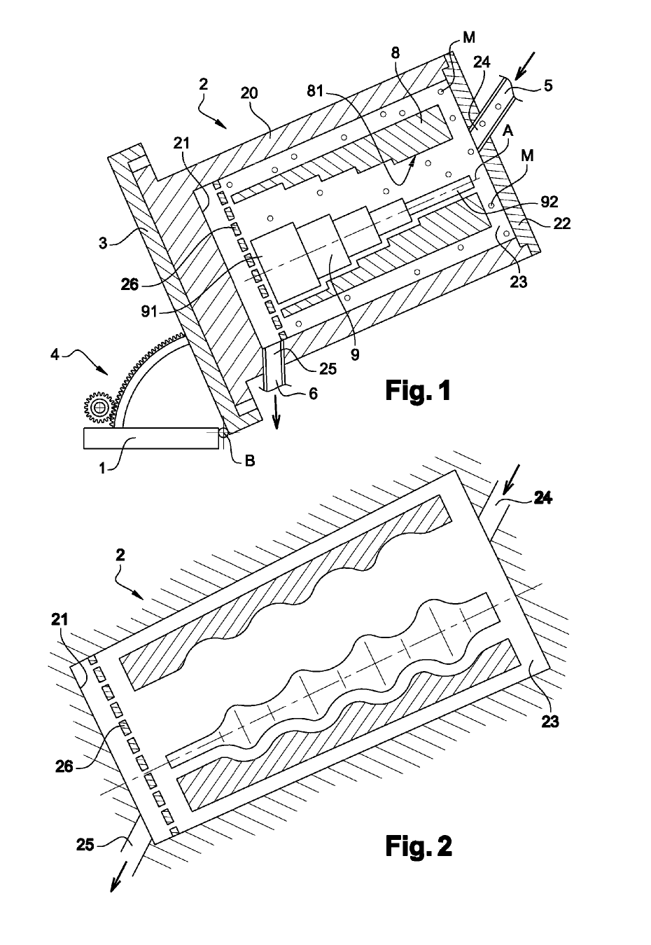

A grinding device according to a first embodiment of the invention, illustrated in FIG. 1, includes a base 1 on which is mounted a chamber 2 in which a divided solid material M is intended to pass so as to be continuously ground. The chamber 2 is supported by stirring means 3 which are provided for imparting to the chamber 2 an oscillatory translational movement in a plane perpendicular to the chamber axis A relatively to the base 1, in a way known per se and not detailed here. The grinding device includes tilting means 4 for adjusting the orientation of the assembly formed by the stirring means 3 and the chamber 2 relatively to the base 1. The orientation is adjusted by pivoting around an axis B perpendicular to the chamber axis A and horizontal. Thus, the chamber axis A moves in a vertical plane.

The chamber 2 has the shape of a container including a cylindrical wall 20, a flat bottom 21 bound to the stirring means 3 and a lid 22, opposite to the bottom 21 closing a cavity 23 of the chamber 2. The chamber 2 includes an inlet orifice 24 for receiving the material M to be treated by crossing the lid 22 and an outlet orifice 25 for extracting the treated material while crossing the bottom 21. These orifices 24, 25 are connected to flexible tubes 5, 6 provided with rotary joints if required, not shown. The bottom 21 is completed with a grid 26 for which the apertures are calibrated depending on the desired size for the material to be recovered after grinding. The outlet orifice 25 is located downstream from the grid 26.

According to the first embodiment, a ring 8 is housed in the chamber 2 and a centrifugal weight 9 crosses a housing 81 of the ring 8. The ring 8 and the centrifugal weight 9 are axisymmetrical parts. They are positioned in the cavity 23 of the chamber 2 with an axis of revolution shifted but substantially parallel to the chamber axis A. The housing 81 and the centrifugal weight 9 include successive variations in diameter per stage and have the same staged profile, the centrifugal weight 9 having a much smaller diameter than the housing 81. Thus, the centrifugal weight 9 is able to roll in the housing 81 while being in contact with the housing 81 over the whole length of the profile. A first end 91 of the centrifugal weight 9 is located facing the bottom 21 and has a first diameter greater than a second diameter of its second end 92 opposite to the first end 91, facing the lid 22. Thus, the centrifugal weight 9 has a global frusto-conical shape, the base 91 of which is on the side of the bottom 21.

During operation, the tilt of the chamber axis A is adjusted with the tilting means 4. The device is supplied with material M in a continuous way through the inlet orifice 24 and the stirring means 3 are activated. These latter make the chamber follow orbits in a plane perpendicular to the chamber axis A, with optionally one rotation of the chamber 2 around its chamber axis A. With this motion, the ring 8 is flattened against the wall 20 and rolls against it while crushing the material M which is interposed between them. Also, the centrifugal weight 9 is flattened against the housing 81 and rolls against it while crossing the material M which is interposed between them. By the tilt which is given to the chamber 2, the material progresses towards the grid 26 which it crosses after having been crushed if its size is smaller than the apertures of the grid, and then towards the outlet orifice 25 and leaves through this route. The grain size of the material at the outlet depends inter alia on the tilt which is adjusted.

In an alternative of the first embodiment, shown in FIG. 2, the profile of the housing 81′ and of the centrifugal weight 9′ is corrugated. The global shape of the centrifugal weight 9′ is also frusto-conical, the base of which is on the side of the bottom 21.

The ratio between the second diameter and the first diameter of the centrifugal weight 9, 9′ is greater than 1.5, preferably greater than 2.

During operation, as earlier, the material is distributed in the space between the chamber 2 and the ring 8′ and between the ring 8′ and the centrifugal weight 9′. A similar effect is obtained as the one described earlier.

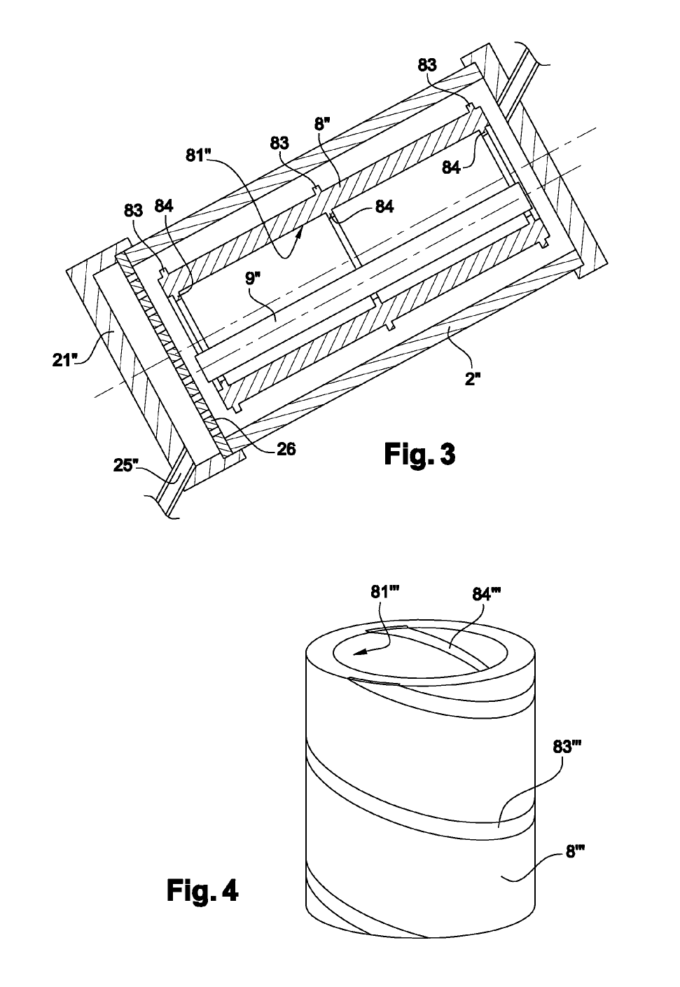

According to a second embodiment, illustrated in FIG. 3, first spacers 83 are inserted between the chamber 2″ and the ring 8″. The first spacers 83 are attached to the periphery of the ring 8″. These are ring sectors for example attached by screwing in three circular grooves made on the outer diameter of the ring 8″ and distributed over the length of the latter. The sectors protrude from the periphery of the ring 8″ so that the ring 8″ rolls into the chamber 2 while being supported on the first spacers 83 and by maintaining a spacing between the chamber 2 and the ring 8″, for example 0.005 mm to a few centimeters.

Also, second spacers 84 are interposed between the ring 8″ and the centrifugal weight 9″ which has a cylindrical shape. The second spacers 84 are attached inside the ring 8″ in the housing 81″ according to a similar technique as the first spacers 83.

The bottom 21″ is completed with the grid 26, the apertures of which are calibrated depending on the spacing defined by the spacers 83, 84. The outlet orifice 25″ is located downstream from the grid 26.

During operation, even if the material M which is placed between the spacers 83, 84 and the chamber 2″ or the centrifugal weight 9″ may be finely crushed, the essential portion of the material remains in the spacings made by the spacers 83, 84 and therefore retain a calibrated grain size with these spacings. As the spacers may be disassembled, it is possible to change them and thus adjust the spacing which they define, depending on the operation which one wishes to carry out.

In an alternative illustrated in FIG. 4, the spacers 83″, 84″′ extend along helices respectively positioned on the peripheral surface of the ring 8″′ and in the housing 81″′.

The invention is not limited to the embodiments described only as an example. The spacers may be also used in the first embodiment. For the first embodiment, the base of the truncated cones may be positioned on the side of the lid. The spacers may be directly obtained by machining the ring, or by other attachment means such as by welding, brazing or by force-fitting.

1-12. (canceled)

13. A continuous grinding device for a divided solid material comprising:
a chamber extending along a chamber axis and including an inlet orifice for receiving a material to be treated and an outlet orifice for extracting the treated material, and a stirring means for imparting to the chamber an oscillatory translational movement in a plane perpendicular to the chamber axis with respect to a base,
a tilting means for adjusting the orientation of an assembly formed by the stirring means and the chamber with respect to the base by pivoting around an oblique or perpendicular axis to the chamber axis,
a ring housed in the chamber and a centrifugal weight crossing a housing of the ring, wherein an external surface of the ring and the housing having a same axis of revolution.

14. The grinding device according to claim 13, wherein the housing includes variations in diameter, the centrifugal weight being of an axisymmetrical shape and having a same profile as the housing.

15. The grinding device according to claim 14, wherein the profile of the housing and of the centrifugal weight is corrugated.

16. The grinding device according to claim 14, wherein the profile of the housing and of the centrifugal weight is staged.

17. The grinding device according to claim 14, wherein a first diameter of a first end of the centrifugal weight is greater than a second diameter of its second end opposite to the first end.

18. The grinding device according to claim 17, wherein a ratio between the first diameter and the second diameter is greater than about 1.5.

19. The grinding device according to claim 13, wherein the housing and the centrifugal weight are cylindrical.

20. The grinding device according to claim 13, wherein first spacers are interposed between the chamber and the ring.

21. The grinding device according to claim 20, wherein the first spacers are attached at a periphery of the ring.

22. The grinding device according to claim 13, wherein second spacers are interposed between the ring and the centrifugal weight.

23. The grinding device according to claim 22, wherein the second spacers are attached inside the ring.

24. The grinding device according to claim 20, wherein the spacers extend along a helix.
